(19) United States
(12) Patent Application Publication
(10) Pub. No.: US 2025/0078129 A1
(43) Pub. Date: Mar. 6, 2025

(54) DATA RANKING AND MODIFICATION SYSTEM

(71) Applicant: SAP SE, Walldorf (DE)

(72) Inventors: Ashish ANAND, Bangalore (IN); Suneet AGARWAL, Bangalore (IN)

(21) Appl. No.: 18/241,047

(22) Filed: Aug. 31, 2023

(51) Int. Cl. G06Q 30/0601

(52) U.S. Cl. CPC G06Q 30/0629

(57) ABSTRACT

Various embodiments for a data ranking and modification system are described herein. An embodiment operates by receiving a selection to organize a plurality of items displayed on the user interface, including at least a first item, a second item, and a third item. It is determined that the plurality of items that are ranked relative to each other. A re-ranking of the first item is detected, the re-ranking moving the first item between the second item and the third item. A midrank between a second rank of the second item and a third rank of the third item is calculated. The midrank is assigned to a first rank of the first item. The first item is automatically moved between the second item and the third item on the user interface based on a comparison of the first rank, second rank, and third rank.

### BACKGROUND

In data management systems, it is often necessary to track or maintain an order of a set of data items, but over time, the order of the data items can change. When the ordering of a data item changes amongst a data set, a system may need to update the numbering of all the affected data items. For example, if item 2 is moved to be placed between items 4 and 5, then a conventional system would need to update the numbering of items 3, 4, and 2. This maintaining and continued renumbering of data items or ranks, each time an order of the items is changed, is both a resource and computationally expensive process. This process becomes even more burdensome and expensive as the size of the set of data set grows and/or the frequency of the re-ordering increases.

### BRIEF DESCRIPTION OF THE FIGURES

The accompanying drawings are incorporated herein and form a part of the specification.

FIG. 1 illustrates a block diagram illustrating a data ranking and modification system (DRS), according to some example embodiments.

FIG. 2 is a flowchart illustrating a process for a data ranking and modification system (DRS), according to some embodiments.

FIG. 3 illustrates an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

In data management systems, it is often necessary to track or maintain an order of a set of data items, but over time, the order of the data items can change. When the ordering of a data item changes amongst a data set, a system may need to update the numbering of all the affected data items. For example, if item 2 is moved to be placed between items 4 and 5, then a conventional system would need to update the numbering of items 3, 4, and 2. This maintaining and continued renumbering of data items or ranks, each time an order of the items is changed, is both a resource and computationally expensive process. This process becomes even more burdensome and expensive as the size of the set of data set grows and/or the frequency of the re-ordering increases.

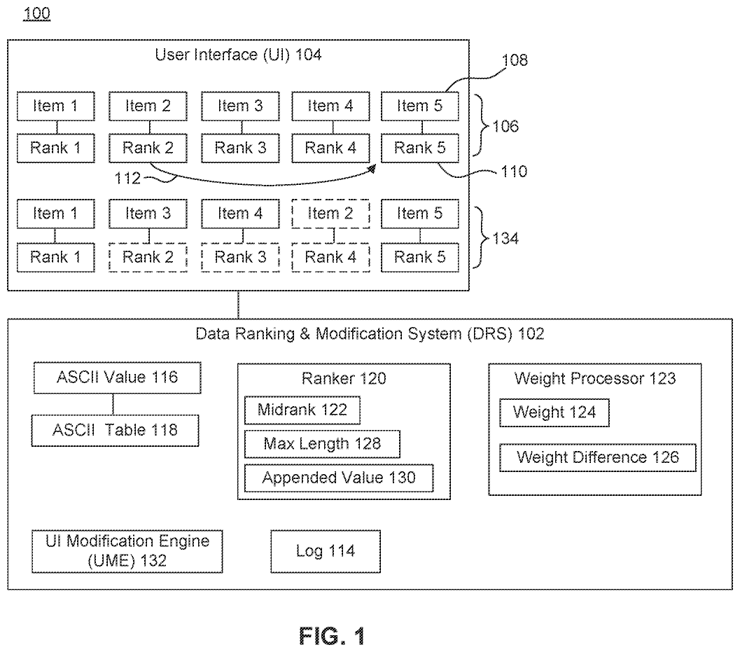

FIG. 1 illustrates a block diagram 100 illustrating a data ranking and modification system (DRS) 102, according to some example embodiments. In some embodiments, DRS 102 may improve computational efficiency required to maintain the order of a set of data, which may be periodically or continually reordered or re-ranked. DRS 102 may provide computationally efficient alternatives to simply renumbering every affected data item when an update occurs which is a computationally expensive process. DRS 102 may also provide or interact with a user interface (UI) 104 that allows a user to perform data re-ranking and/or display the re-ranked results of processing.

UI 104 may include a display of an initial data set 106. Data set 106 may include a set of data items 108 (items 1-5) and corresponding ranks 110 (ranks 1-5) of the data items. Data items or items 108 may include any data values that may be stored in a database, a data table, or another storage device. Ranks 110 may include an order or relative ranking between the items 108. For simplicity, only 5 items 108 and ranks 110 are illustrated, however it is understood that any number of items 108 and corresponding ranks 110 may be used in various embodiments.

The arrow indicates a re-ranking action 112 of an item 108. In the example illustrated, item 2 may be re-ranked to be between items 4 and 5. In some embodiments, the re-ranking 112 may be performed by a user via the UI 104, for example, by performing a drag-and-drop action moving item 2 between items 4 and 5.

In some embodiments, the re-ranking 112 may be illustrative of a sort or ordering operation performed by a backend system (not illustrated) based on one or more parameters. For example, items 108 may be ticker symbols for stocks, and as the price of the stocks changes, a system may re-order or re-rank the stocks based on their most up-to-the-second price. In some embodiments, the order or rank of the stocks (items 108) may indicate or impact stock buy and sell decisions, or the relative portfolio holdings.

A conventional system may use integers for the ranking values 110. For example, rank 1=1, rank 2=2, and so on. Then, when a re-ranking is requested (as illustrated), the conventional system changes the value of each of the affected ranks. For example, the value for the rank for item 3 may be changed from 3 to 2, the value for the rank for item 4 may be changed from 4 to 3, and the value for the rank of item 2 may be changed from 2 to 4. The problem with this approach is that it is very computationally expensive, especially as the size of the data set 106 (and number of rankings 110) and/or frequency of re-ranking 112 increases. DRS 102 addresses this issue with computationally efficient ways of re-ranking 112 items 108 in a data set 106, without having to renumber or re-index every intervening rank value.

In some embodiments, to improve this efficiency, decimal values may be used in lieu of integers for the values of ranks 110. For example, if item 2 with rank value 2 is to be moved between items 4 and 5 with rank values 4 and 5 respectively, the rank value of item 2 may be changed to rank value 4.5. In this way, the re-ranking 112 of item 2 is performed more efficiently as only one value is changed.

However, if the system continually or frequently re-ranks the items, at a certain point there may be no more decimal values available and the re-indexing must again be performed. For example, if a first item is to be moved between a second item with rank 2.4 and a third item with rank 2.5, if the system is limited to one decimal space, there is no additional values available, so a renumbering or re-indexing operation would need to be performed.

To improve on this efficient, in some embodiments, DRS 102 may use string values for the ranks 110. Each string value may include a set of one or more alphanumeric and/or symbolic or special character values. For example, if a rank 110 has a length of 3, then each of the three values or characters in the rank 110 may comprise one of:
‘!’, ‘″’, ‘#’, ‘$’, ‘%’, ‘&’, ‘′″’, ‘+’, ‘(′, ′)’, ‘*’, ‘,’, ‘-’, ‘.’, ‘0’, ‘1’, ‘2’, ‘3’, ‘4’, ‘5’, ‘6’, ‘7’, ‘8’, ‘9’, ‘:’, ‘;’, ‘<’, ‘=’, ‘>’, ‘?’, ‘@’, ‘A’, ‘B’, ‘C’, ‘D’, ‘E’, ‘F’, ‘G’, ‘H’, ‘I’, ‘J’, ‘K’, ‘L’, ‘M’, ‘N’, ‘O’, ‘P’, ‘Q’, ‘R’, ‘S’, ‘T’, ‘U’, ‘V’, ‘W’, ‘X’, ‘Y’, ‘Z’, ‘[′, ‘\\’, ′]’, ‘\hat{ }’, ‘_’, ‘'’, ‘a’, ‘b’, ‘c’, ‘d’, ‘e’, ‘f’, ‘g’, ‘h’, ‘i’, ‘j’, ‘k’, ‘l’, ‘m’, ‘n’, ‘o’, ‘p’, ‘q’, ‘r’, ‘s’, ‘t’, ‘u’, ‘v’, ‘w’, ‘x’, ‘y’, ‘z’, ‘{′, ‘|’, ′}’, ‘˜’

The rank 110 itself may include a combination of any three selected values, such as ABC, or v!0. Using string values may consume less space than decimals and may enable many more possible combinations for ranks 110, which would avoid, delay, or reduce the frequency of the computationally expensive renumbering as described above in a conventional system. Using strings with a variety of possibly characters, in lieu of just numeric values, increases the available combinations exponentially relative to using either integers or decimals, and thus improves system efficiency while performing re-ranking.

In some embodiments, to compute a new string value between two existing string values (for different ranks 110), DRS 102 may compute a mean of one or more (or each) of the characters in each string value, and use the computed mean as the new string value (for the new rank). Below is provided pseudocode for calculating the mean of two characters:
Define function getCharacterMean(character1, character2){
   Define mean=(ASCIIValueOf(character1)+ASCIIValueOf(character1))/2.
   Return CharacterAtASCIICode (mean).
}

This function may be used to calculate the mean or midrank 122 between two or more strings, as provided in the pseudocode below:
Define string formerRank which stores rank of the former item.
Define string laterRank which stores rank of the later item.
Define string midRank which stores the rank in between formerRank and laterRank to initial.
Define string maxLen which store the length of formerRank or laterRank, whichever is lengthier.
Loop maxLen times.
   Define character midChar.
   midChar=mean of character at loop index of formerRank and laterRank.
   midRank=midRank+midChar.
End loop.
If midRank equals formerRank.
   midRank=midRank+“0”.
End if.
If midRank equals laterRank.
   Throw error “no mid rank is feasible between formerRank and laterRank”.
End if.
Return midRank.

A ranker 120 may execute the pseudocode described above. In some embodiments, the ranker 120 may determine a value of a particular alphanumeric and symbolic or special characters based on the ASCII (American Standard Code for Information Interchange) standard. ASCII may be a standard used for encoding characters, which may include 128 different characters that may be used or referenced. Each ASCII character may include or have a corresponding decimal, hexadecimal, or binary value which may be used for the ordering or ranking between the various characters when used for ranks 110. In some embodiments, the ASCII value 116 for the various characters of a rank 110 may be retrieved from an ASCII table 118.

The characters above are provided in ascending ASCII value order. For example, “!” has a lower value than “C”, which has a lower value than “a”. In other embodiments, different sets or subsets of the 128 different possible characters may be selected for and used in ranks 110. For example, in an embodiments, ranks 110 may be limited to numbers, uppercase letters, and lowercase letters, and symbols may be excluded.

In some embodiments, when DRS 102 detects a re-ranking request or command 112, DRS 102 (e.g., ranker 120) may retrieve the ranks 110 for the affected items 103. In the example re-ranking 112 illustrated in FIG. 1, the affected items may be item 2, and items 4 and 5 between which item 2 is being moved or re-ranked. As described above, these ranks 110 may be string values with a plurality of characters, which may be stored in a database (not illustrated), or in a log 114. Log 114 may include one or more log files that track present and past ranks 110 for the various items 108 that may be displayed on UI 104. In some embodiments, DRS 102 may retrieve the ranks 110 for items 2, 4, and 5 from log 114. For example, rank 2 may be “+FZ”, rank 4 may be “1Ab” and rank 5 may be “fgh”. For simplicity, all the ranks 110 have the same length, however as described in greater detail below, different ranks 110 may include different lengths or different numbers of characters.

Ranker 120 may also retrieve the ASCII value 116 for each character of the ranks 110 from an ASCII table 118. ASCII table 118 may include a mapping of the various characters used in the ranks 110 to their corresponding values. For example, ! may correspond to an ASCII value of 1, ″ may correspond to an ASCII value of 2, # may correspond to an ASCII value of 3, and so on. In other embodiments, the various characters may be assigned different values (other than the predetermined ASCII values described above) in ASCII table 118. For example, in some embodiments, a system may have a customized value ranking specific for a particular user or application.

In some embodiments, ranker 120 may calculate or generate a midrank 122 based on the ranks between which a selected item is being re-ranked. For example, ranker 120 may generate a midrank 122 for the values of rank 4 and rank 5. Midrank 122 may be any value in between two other values, such as the mean value as described above. For example, the midrank 122 between 1 and 10 may be 5 (which may be the value closest to the midway point between the two values). In some embodiments, the midrank 122 may be rounded either up or down if it does not fall on a specific value or character. In some embodiments, the midrank between 1-10 may be any value between 2-9.

Ranker 120 may select the value closest to the midway point, because this would maximize the opportunity for other rankings to be later included. For example, if midrank 122 of 5 was selected, then there may be three new ranking values that can be inserted between 1-5 (2, 3, 4) and four new values between 5-10 (6, 7, 8, 9). This may maximize the insertion of new re-rankings without additional processing as will be described below. In some embodiments, ranker 120 may select 6 instead of 5 for the midrank value 122, thus creating four previous values between 1-6 and three latter values between 6-10.

The example pseudocode provided above with regard to calculating the mean between two strings and two characters may be executed by ranker 120 in calculating midrank 122. As indicated in the code above, the ranker 120 may calculate the mean of two characters by computing the means of the ASCII values 116 for both characters.

In continuing the example above in which rank 4 may be “1Ab” and rank 5 may be “fgh”, ranker 120 may compute a midrank 122 based on the mean of (1, f) for the first character, (A, g) for the second character, and (b, h) for the third character. In some embodiments, this may produce a midrank 122 of “LUe” which may be assigned to item 2 and replace the value “+FZ” previously assigned to rank 2. DRS 102 may also write these changes to log 114.

In some embodiments, it may be that there are no available in-between ranks between rank 4 and rank 5, which may have values “c” and “c!” respectively. In these types of cases, where no in-between ranks can be included, DRS 102 may either append a new value or perform a partial re-indexing (referred to herein as re-indexing).

In some embodiments, if there is no available characters between two different ranks (e.g., rank 4 is cA and rank 5 is cB), then if item 2 was to be moved between items 4 and 5, ranker 120 may add an appended value 130 to rank 4, for the new value of rank 2 for item 2. In the example above, the appended value 130 may be “0”, such that rank 2 may be given the value “cA”. This may allow for new items to be inserted between items 4 and 2, or items 2 and 5. However, this may only be done up until a max length 128 is reached. In some embodiments, there may be a max length 128 indicating the maximum number of characters, such as 5 for a rank 110. If there are no available values between the ranks and the max length 128 has been reached, DRS 102 may perform a re-indexing or renumbering operation.

In a re-indexing operation one of the values of rank 4 or 5 would be changed, but not both. In the example described above, because there is no item 6, rank 5 for item 5 may be increased by some factor and then rank 2 would be changed to the midrank 122 or mid value between rank 4 and the new rank 5 value. In some embodiments, the factor may a set factor, such as 20 where 20 values may exist between rank 4 and rank 5. In some embodiments, the factor may be calculated by DRS 102 based on the frequency of re-rankings, where a greater frequency could result in a larger value of rank 5.

However, if there was another item 6 with rank 6 following item 5 and rank 5, then DRS 102 would first need to determine whether to alter the value of rank 4 or rank 5 to make room for the new re-ranked item 2 between items 4 and 5 respectively. In some embodiments, a weight processor 123 may determine which rank 110 should be re-ranked and by how much (e.g., what the new rank value will be).

In some embodiments, weight processor 123 may determine, calculate, or generate a weight 124 for the various ranks 110. Weight processor 123 may then calculate a weight difference 126 between two of the weights 124 of the ranks 110, to determine how far away the ranks are from each other. In some embodiments, the weighted difference 126 may not indicate the exact number of possible values that exist between two ranks 110, but may simply indicate which is greater: the distance between ranks 3-4 or the distance between ranks 5-6. The greater weight may indicate that more values may be accommodated by re-indexing in that direction, and may be chosen accordingly.

As such, weight processor 123 may calculate the weighted difference 126 between ranks 3 and 4, and the weighted difference 126 between ranks 5 and 6. Weight processor 123 may then compare the two weight differences 126, and the side with the greater weighted difference 126 may be selected for re-indexing while the other side rank remains the same. For example, if the weighted difference 126 for 3-4 is greater than for 5-6, then the value of rank 4 may be changed/re-indexed and the value for rank 5 may remain the same. If the weighted difference are equal, than DRS 102 may select either rank for re-indexing, which may default to the prior rank (e.g., rank 4).

Example pseudocode for calculating the weight 124 for a rank is provided below:

```
function getRank Weight(rank){
  var len = rank.length;
  var weight = 0;
  for(var i=0;i<len;i++){
    weight += rank.charCodeAt(i) * Math.pow(10, len - i -1);
  }
  return weight;
}
```

As described above, there are possible 94 possible characters which may be included in value for a rank 110. In the example pseudocode provided above, rather than calculating an exact weight for all 94 characters (which is possible but consumes many more computing processing cycles), DRS 102 may select and any number less than 94. In the example provided above, 10 is selected for computing a rank weight rather than the exact count of 94. In other embodiments, other values may be selected. By selecting the value 10 (or another lesser value than the total possible characters 94), DRS 102 is able to save value computing cycles, reduce processing time, and increase system throughput by using a weight difference 126 comparison, rather than an actual value count for the numerous character variations between two ranks 110. In other embodiments, different values could be selected in lieu of 10, such as 5, or 30. However, the process of comparing weight differences 126 would remain the same.

As an example, item 3 may have a rank of “b”, item 4 may have a rank of “c”, item 5 may have a rank of “c!” and item 6 may have a rank of “c0”. Rank processor 123 may calculate a rank weight for ranks 3-6 respectively as: 98, 99, 1023, and 1038. Rank processor 123 may then calculate the weight differences 126 as being 1 (99-98) and 15 (1038-1023) respectively. Based on the comparison, rank 5 may be re-indexed, while rank 4 may remain the same. Ranker 120 may calculate a midrank 122 between rank 5 “c!” and “c0” which may be assigned to rank 5 as the new rank 5. Ranker 120 may then calculate a midrank 122 between the new rank 5 and rank 4, and this value may be assigned to the rank for item 2 which is now ranked between items 4 and 5.

In the example above, if there is no space between either 3-4 or 5-6, then DRS 102 may recursively check further out ranked items 108 until a gap is found between two rank values to accommodate the insertion of item 2 between items 4-5. For example, if the rank values were: c! c!! c!!! and c!!!!, then there may not be any sufficient space for inserting a new rank, and recursive checks may be performed. Example pseudocode for performing the recursive checks for re-indexing is provided below:

```
function reindex(arrItem,index1,index2){
  var aChanged = [ ];
  var wd1 = getWeightedDifference(arrItem[index1-1].rank,arrItem[index1].rank);
  var wd2 = getWeightedDifference(arrItem[index2].rank,arrItem[index2+1].rank);
  var shiftRank1,shiftRank2,index;
    if(wd1>wd2){
      shiftRank 1 = index1 -1;
      index = shiftRank2 = index1;
    }else{
      index = shiftRank1 = index2;
      shiftRank2 = index2 + 1;
    }
  try {
    arrItem[index].rank =
findMidStr(arrItem[shiftRank1].rank,arrItem[shiftRank2].rank);
  } catch (error) {
    aChanged = aChanged.concat(reindex(arrItem,shiftRank1,shiftRank2));
    arrItem[index].rank =
findMidStr(arrItem[shiftRank1].rank,arrItem[shiftRank2].rank);
  }
  aChanged.push(arrItem[index]);
  return aChanged;
}
function reorder(arrItem,initPos,finalPos){
  var aChanged = [ ],
  oltem = arrItem[initPos],
  prevIndex = finalPos-1,
  nextIndex = finalPos,
  oPrevItem = arrItem[prevIndex],
  oNextItem = arrItem[nextIndex];
  try {
    oltem.rank = findMidStr(oPrevItem.rank,oNextItem.rank);
  } catch (error) {
    aChanged = aChanged.concat(reindex(arrItem,prevIndex,nextIndex));
    oltem.rank = findMidStr(oPrevItem.rank,oNextItem.rank);
  }
  aChanged.push(oltem);
  return aChanged;
}
```

In some embodiments, different ranks 110 may have different lengths up to a max length 128. For example, rank 2 may include two characters, and rank 3 may include 4 characters.

In some embodiments, a UI modification engine (UME) 132 may update the ordering of the items 108 from data set 106 displayed in UI 104 in accordance with the new ranks provided by ranker 120, as illustrated in updated data set 134.

Updated data set 134 may indicate the new ordering or ranking of the original data set 106 after processing by DRS 102 as described herein. The dashed line boxes may indicate those values that have been updated by ranker 120, based on the movement of item 2 to its new location between items 4 and 5.

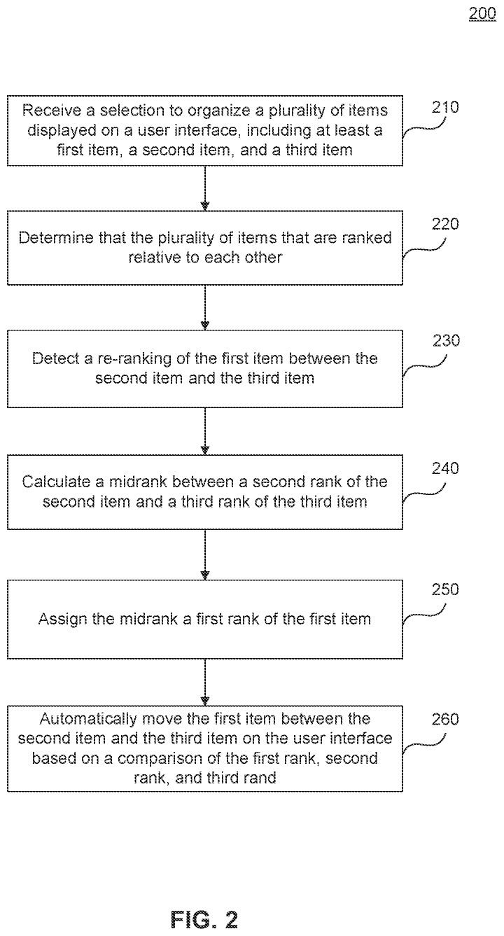

FIG. 2 is a flowchart illustrating a process 200 for a data ranking and modification system (DRS) 102, according to some embodiments. Method 200 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 2, as will be understood by a person of ordinary skill in the art. Method 200 shall be described with reference to the figures.

In 210, a selection to organize a plurality of items displayed on a user interface is received, including at least a first item, second item, and third item. For example, a user may select a menu option (not displayed) from UI 104 that may enable the user to edit or re-rank the items 108 displayed in the data set 106. In some embodiments, DRS 102 may make sure the user has permissions to perform the re-ranking, or may first check to see that the items 108 are not being re-ranked by another system or user. The plurality of items 108 may include items 1-5. In other embodiments, different numbers of items may be displayed on the UI 104 or otherwise ranked as described herein.

In 220, it is determined that the plurality of items are ranked relative to each other. For example, each of the items 108 may include or have a corresponding rank 110. The actual values for ranks 110 may or may not be displayed in various embodiments, but may be implied by the order in which the items 108 are displayed. In some embodiments, the ranks 110 may include string values, or a group of characters.

In 230, a re-ranking of the first item is detected between the second item and third item. For example, a user may move item 2 to be in between items 4 and 5, as illustrated on UI 104 by re-ranking operation 112. Or, for example, DRS 102 may receive a notification that the items 108 are to be re-ranked due to some change in a parameter used in calculating the ranking values. For example, the items 108 may be user interface items for an app or application that are ranked according to usage by a community of users, and as the usage numbers change, the items 108 may be re-ranked. Or, for example, the items 108 may be ranked based on stock price, and as the price is updated, the items are re-ranked.

In 240, a midrank between a second rank of the second item and a third rank of the third item is calculated. For example, a ranker 120 may calculate midrank 122 for ranks 4 and 5. If there are multiple characters in the ranks 110, ranker 120 may do a character-by-character analysis to determine the new rank for item 2. If there are no remaining values between rank 4 and rank 5, and the length of rank 4 is less than a max length 128, ranker 120 may add appended value 130 to the end of rank 4 to create a new rank of a different length between existing ranks 4 and 5. In some embodiments, if the max length 128 has been reached, then ranker 120 may perform a re-ranking or re-indexing of one of rank 4 or rank 5.

In 250, the midrank is assigned to a first rank of the first item. For example, ranker 120 may assign midrank 122 to rank 2 for item 2.

In 260, the first item is automatically moved between the second item and the third item on the user interface based on a comparison of the first rank, second rank, and third rank. For example, UIE 132 may compare the new value of rank 2 to the values for ranks 1 and 3-5 to determine where to move item 2 on the UI. UIE 132 may then change the UI 104 from the original data set 106, to the updated data set 134 in which the items 108 have been re-ordered in accordance with the new value(s) for the rank 110.

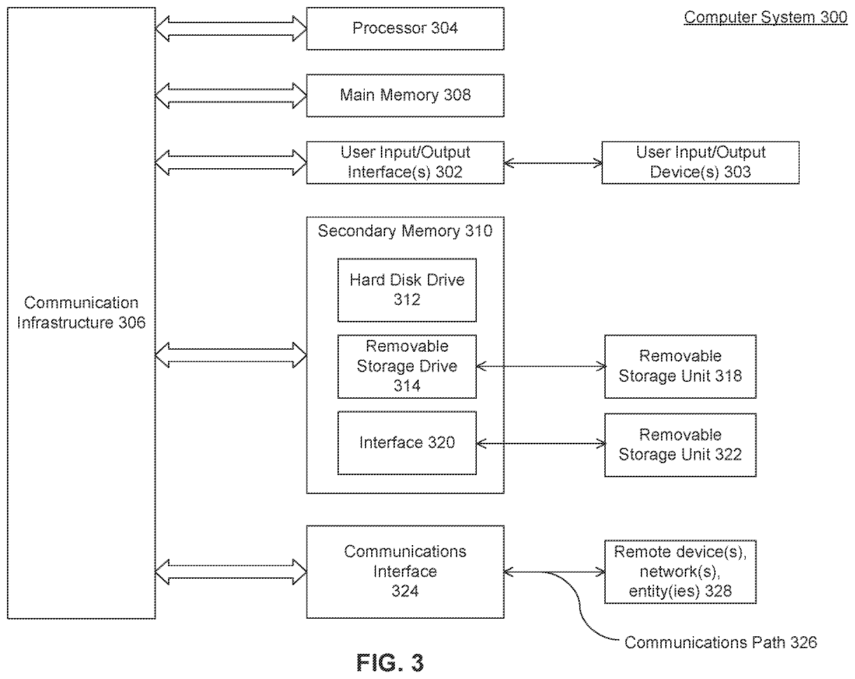

Various embodiments and/or components therein can be implemented, for example, using one or more computer systems, such as computer system 300 shown in FIG. 3. Computer system 300 can be any computer or computing device capable of performing the functions described herein. For example, one or more computer systems 300 can be used to implement any embodiments, and/or any combination or sub-combination thereof.

Computer system 300 includes one or more processors (also called central processing units, or CPUs), such as a processor 304. Processor 304 is connected to a communication infrastructure or bus 306. Computer system 300 may represent or comprise one or more systems on chip (SOC).

One or more processors 304 can each be a graphics processing unit (GPU). In some embodiments, a GPU is a processor that is a specialized electronic circuit designed to process mathematically intensive applications. The GPU can have a parallel structure that is efficient for parallel processing of large blocks of data, such as mathematically intensive data common to computer graphics applications, images, videos, etc.

Computer system 300 also includes user input/output device(s) 303, such as monitors, keyboards, pointing devices, etc., that communicate with communication infrastructure 306 through user input/output interface(s) 302.

Computer system 300 also includes a main or primary memory 308, such as random access memory (RAM). Main memory 308 can include one or more levels of cache. Main memory 308 has stored therein control logic (i.e., computer software) and/or data.

Computer system 300 can also include one or more secondary storage devices or memory 310. Secondary memory 310 can include, for example, a hard disk drive 312 and/or a removable storage device or drive 314. Removable storage drive 314 can be a floppy disk drive, a magnetic tape drive, a compact disk drive, an optical storage device, tape backup device, and/or any other storage device/drive.

Removable storage drive 314 can interact with a removable storage unit 318. Removable storage unit 318 includes a computer usable or readable storage device having stored thereon computer software (control logic) and/or data. Removable storage unit 318 can be a floppy disk, magnetic tape, compact disk, DVD, optical storage disk, memory card, and/any other computer data storage device. Removable storage drive 314 reads from and/or writes to removable storage unit 318 in a well-known manner.

According to an exemplary embodiment, secondary memory 310 can include other means, instrumentalities or other approaches for allowing computer programs and/or other instructions and/or data to be accessed by computer system 300. Such means, instrumentalities or other approaches can include, for example, a removable storage unit 322 and an interface 320. Examples of the removable storage unit 322 and the interface 320 can include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 300 can further include a communication or network interface 324. Communication interface 324 enables computer system 300 to communicate and interact with any combination of remote devices, remote networks, remote entities, etc. (individually and collectively referenced by reference number 328). For example, communication interface 324 can allow computer system 300 to communicate with remote devices 328 over communications path 326, which can be wired and/or wireless, and which can include any combination of LANs, WANs, the Internet, etc. Control logic and/or data can be transmitted to and from computer system 300 via communication path 326.

In some embodiments, a tangible apparatus or article of manufacture comprising a tangible computer useable or readable medium having control logic (software) stored thereon is also referred to herein as a computer program product or program storage device. This includes, but is not limited to, computer system 300, main memory 308, secondary memory 310, and removable storage units 318 and 322, as well as tangible articles of manufacture embodying any combination of the foregoing. Such control logic, when executed by one or more data processing devices (such as computer system 300), causes such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 3. In particular, embodiments can operate with software, hardware, and/or operating system implementations other than those described herein.

It is to be appreciated that the Detailed Description section, and not the Summary and Abstract sections, is intended to be used to interpret the claims. The Summary and Abstract sections can set forth one or more but not all exemplary embodiments as contemplated by the inventors, and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A method, comprising:
receiving, via a user interface, a selection to organize a plurality of items displayed on the user interface, wherein the plurality of items include at least a first item, a second item, and a third item;
determining that the plurality of items are ranked relative to each other, wherein a rank of each of the plurality of items comprises a string value;
detecting a re-ranking of the first item, wherein the re-ranking moves the first item between the second item and the third item;
calculating a midrank between a second rank of the second item and a third rank of the third item, wherein the midrank comprises a string value between the second rank and the third rank;
assigning the midrank a first rank of the first item, and
automatically moving the first item between the second item and the third item on the user interface based on a comparison of the first rank, second rank, and third rank.

2. The method of claim 1, wherein the plurality of items comprise more than three items.

3. The method of claim 1, wherein the calculating comprises;
determining that the string value for each of the first rank, second rank, and third rank comprise a plurality of characters;
calculating a first midvalue based on a comparison of a first value of the second rank to a first value of the third rank;
calculating a second midvalue based on a comparison of a second value of the second rank to a second value of the third rank; and
generating the midrank comprising at least the first midvalue and the second midvalue.

4. The method of claim 3, further comprising:
determining that the second rank comprises more characters than the third rank; and
for each additional character in the second rank, appending a new value to the midrank.

5. The method of claim 4, wherein the new value comprises an alphanumeric or symbolic character with a lowest ASCII (American Standard Code for Information Interchange) value.

6. The method of claim 3, further comprising:
determining that the third rank comprises more characters than the second rank; and
for each additional character in the third rank, appending a new value to the midrank, wherein the new value comprises an alphanumeric or symbolic character with a highest ASCII (American Standard Code for Information Interchange) value.

7. The method of claim 1, wherein the calculating comprises:
determining that there are no available string values between the second rank and the third rank;
determining that there are more available string values between the third rank and a fourth rank of a fourth item of the plurality of items than there are between the second rank and a fifth rank of a fifth item of the plurality of items;
calculating a first midrank between the third rank and the fourth rank;
assigning the first midrank to the third rank; and
calculating a second midrank between the second rank and the third rank comprising the first midrank, wherein the second midrank is assigned to the first rank.

8. A system comprising at least one processor, the at least one processor configured to perform operations comprising:
receiving, via a user interface, a selection to organize a plurality of items displayed on the user interface, wherein the plurality of items include at least a first item, a second item, and a third item;
determining that the plurality of items are ranked relative to each other, wherein a rank of each of the plurality of items comprises a string value;
detecting a re-ranking of the first item, wherein the re-ranking moves the first item between the second item and the third item;
calculating a midrank between a second rank of the second item and a third rank of the third item, wherein the midrank comprises a string value between the second rank and the third rank;
assigning the midrank a first rank of the first item; and
automatically moving the first item between the second item and the third item on the user interface based on a comparison of the first rank, second rank, and third rank.

9. The system of claim 8, wherein the plurality of items comprise more than three items.

10. The system of claim 8, wherein the calculating comprises:
determining that the string value for each of the first rank, second rank, and third rank comprise a plurality of characters;
calculating a first midvalue based on a comparison of a first value of the second rank to a first value of the third rank;
calculating a second midvalue based on a comparison of a second value of the second rank to a second value of the third rank; and
generating the midrank comprising at least the first midvalue and the second midvalue.

11. The system of claim 10, the operations further comprising:
determining that the second rank comprises more characters than the third rank; and
for each additional character in the second rank, appending a new value to the midrank.

12. The system of claim 11, wherein the new value comprises an alphanumeric or symbolic character with a lowest ASCII (American Standard Code for Information Interchange) value.

13. The system of claim 10, the operations further comprising:
determining that the third rank comprises more characters than the second rank; and
for each additional character in the third rank, appending a new value to the midrank, wherein the new value comprises an alphanumeric or symbolic character with a highest ASCII (American Standard Code for Information Interchange) value.

14. The system of claim 8, wherein the calculating comprises:
determining that there are no available string values between the second rank and the third rank;
determining that there are more available string values between the third rank and a fourth rank of a fourth item of the plurality of items than there are between the second rank and a fifth rank of a fifth item of the plurality of items;
calculating a first midrank between the third rank and the fourth rank;
assigning the first midrank to the third rank; and
calculating a second midrank between the second rank and the third rank comprising the first midrank, wherein the second midrank is assigned to the first rank.

15. A non-transitory computer-readable medium having instructions stored thereon that, when executed by at least one computing device, cause the at least one computing device to perform operations comprising:
receiving, via a user interface, a selection to organize a plurality of items displayed on the user interface, wherein the plurality of items include at least a first item, a second item, and a third item;
determining that the plurality of items are ranked relative to each other, wherein a rank of each of the plurality of items comprises a string value;
detecting a re-ranking of the first item, wherein the re-ranking moves the first item between the second item and the third item;
calculating a midrank between a second rank of the second item and a third rank of the third item, wherein the midrank comprises a string value between the second rank and the third rank;
assigning the midrank a first rank of the first item; and
automatically moving the first item between the second item and the third item on the user interface based on a comparison of the first rank, second rank, and third rank.

16. The non-transitory computer-readable medium of claim 15, wherein the plurality of items comprise more than three items.

17. The non-transitory computer-readable medium of claim 15, wherein the calculating comprises:
determining that the string value for each of the first rank, second rank, and third rank comprise a plurality of characters;
calculating a first midvalue based on a comparison of a first value of the second rank to a first value of the third rank;
calculating a second midvalue based on a comparison of a second value of the second rank to a second value of the third rank; and
generating the midrank comprising at least the first midvalue and the second midvalue.

18. The non-transitory computer-readable medium of claim 17, the operations further comprising:
determining that the second rank comprises more characters than the third rank; and
for each additional character in the second rank, appending a new value to the midrank.

19. The non-transitory computer-readable medium of claim 18, wherein the new value comprises an alphanumeric or symbolic character with a lowest ASCII (American Standard Code for Information Interchange) value.

20. The non-transitory computer-readable medium of claim 15, the operations further comprising:
determining that the third rank comprises more characters than the second rank; and
for each additional character in the third rank, appending a new value to the midrank, wherein the new value comprises an alphanumeric or symbolic character with a highest ASCII (American Standard Code for Information Interchange) value.
